(19) United States
(12) Patent Application Publication
(10) Pub. No.: US 2011/0129026 A1
(43) Pub. Date: Jun. 2, 2011

(54) METHOD AND APPARATUS FOR TRANSMITTING AND RECEIVING DATA USING FREQUENCY DIVERSITY SCHEME

(75) Inventors: Jung-Sun UM, Gyeonggi-do (KR); Sung-Hyun Hwang, Gyeonggi-do (KR); Gwangzeen Ko, Gyeonggi-do (KR); Myung-Sun Song, Gyeonggi-do (KR); Chang-Joo Kim, Gyeonggi-do (KR)

(73) Assignee: ELECTRONICS AND TELECOMMUNICATIONS RESEARCH INSTITUTE, Daejeon-city (KR)

(21) Appl. No.: 12/990,565

(22) PCT Filed: May 1, 2009
(86) PCT No.: PCT/KR09/02330

§ 371 Date: Nov. 1, 2010

(30) Foreign Application Priority Data
May 2, 2008 (KR) 10-2008-0041488
May 1, 2009 (KR) 10-2009-0038675

(51) Int. Cl. H04L 27/00; H04L 27/28

(52) U.S. Cl. 375/260; 375/295; 375/316

(57) ABSTRACT

Provided are a transmitter and a receiver. The transmitter combines N data signals received from an encoded bit stream to generate N symbols; maps the N symbols to subcarriers that are spaced more than a coherent bandwidth apart; and receives and moves the N symbols, which are mapped to the subcarriers that are spaced more than a coherent bandwidth apart, to their own positions. The receiver demodulates N pieces of data using the N symbols received from the transmitter in a manner similar to that used by the transmitter.

### TECHNICAL FIELD

The present invention relates to a method and apparatus for transmitting and receiving data to obtain a frequency diversity gain by using the feature of frequency-selective fading in a wireless communication system, and more particularly, to a method and apparatus for transmitting and receiving data by using at least one transmit and receive antenna without data transfer rate degradation and space limitations.

### BACKGROUND ART

Various methods have been used to stably transmit and receive data in a wireless mobile communication system, for example, a space diversity scheme, a time diversity scheme, a frequency diversity scheme, or a combination thereof.

The space diversity scheme achieves antenna diversity by using a plurality of transmit and receive antennas or a plurality of receivers. However, the space diversity scheme has a drawback in that a plurality of receivers are used.

The time or frequency diversity scheme allocates data for different times or different frequencies and transmits the data at different instants of time or by using different frequency channels. The time diversity scheme may use time hopping so as to use additionally transmitted delayed signals or delayed multipath signals that are received by a receiver.

The frequency diversity scheme may use frequency hopping. As an example of the frequency diversity scheme, there is an orthogonal frequency division multiplexing (OFDM) transmission scheme that has been recently used in various communication systems. The OFDM transmission scheme involves dividing data having a high data transfer rate into a plurality of data streams having low data transfer rates and simultaneously transmitting the data streams using a plurality of subcarriers.

In particular, if the OFDM transmission scheme uses a subcarrier allocation technique such as interleaving, since closely spaced pieces of data are transmitted to subcarriers that are at a distance, frequency diversity may be achieved. However, since the same data is copied and then transmitted to different subcarriers, a frequency diversity gain can be obtained but a data transfer rate is reduced compared to the OFDM that does not use a subcarrier allocation technique such as interleaving.

In addition, multiple antenna technology, which is also used to stably transmit and receive data, also suffers space limitations, and data transfer rate degradation because the same data is copied and then is transmitted to different subcarriers.

### DESCRIPTION OF THE DRAWINGS

FIG. 1 is a graph illustrating frequency selective fading.

FIG. 2 is a block diagram of a transmitter for combining N (=2) pieces of data, according to an embodiment of the present invention.

FIG. 3 is a block diagram of a receiver according to an embodiment of the present invention.

FIG. 4 is a graph illustrating performance of transmitting method according to an embodiment of the present invention, which is achieved when quadrature phase-shift keying (QPSK) is used at a code rate of 1/2 according to the IEEE802.22 standard.

### DETAILED DESCRIPTION OF THE INVENTION

### Technical Problem

The present invention provides a method and apparatus for transmitting and receiving data by using at least one transmit and receive antenna without data transfer rate degradation and space limitations.

### Technical Solution

According to an aspect of the present invention, there is provided a transmitter including: a data combining unit combining N data signals received from an encoded bit stream to generate N symbols; and a subcarrier allocating unit mapping the N symbols to subcarriers that are spaced more than a coherent bandwidth apart.

According to another aspect of the present invention, there is provided a receiver including: a receiving unit receiving N symbols that are generated by combining N data signals and mapped to subcarriers that are spaced more than a coherent bandwidth apart; a subcarrier de-allocating unit moving the N symbols, which are mapped to the subcarriers that are spaced more than a coherent bandwidth apart, to their original own positions; and a data separating unit separating N pieces of data from the N symbols, which are moved to their own positions and demodulating the N pieces of data.

### Advantageous Effects

According to the present invention, a frequency diversity gain can be obtained without reducing a data transfer rate. Since a frequency domain signal corresponding to a time domain signal can be transmitted in a single-carrier transmission scheme, the present invention can be used in the single-carrier transmission scheme as well as in a multi-carrier transmission scheme. Furthermore, the present invention can be used in a single-input/single-output (SISO) antenna system, a multi-input/multi-output (MIMO) antenna system using a multiple transmit and receive antenna, or a method using a variance receiver.

### Best Mode

According to an aspect of the present invention, there is provided a transmitter including: a data combining unit combining N data signals received from an encoded bit stream to generate N symbols; and a subcarrier allocating unit mapping the N symbols to subcarriers that are spaced more than a coherent bandwidth apart.

According to another aspect of the present invention, there is provided a receiver including: a receiving unit receiving N symbols that are generated by combining N data signals and mapped to subcarriers that are spaced more than a coherent bandwidth apart; a subcarrier de-allocating unit moving the N symbols, which are mapped to the subcarriers that are spaced more than a coherent bandwidth apart, to their original own positions; and a data separating unit separating N pieces of data from the N symbols, which are moved to their own positions and demodulating the N pieces of data.

### Mode of the Invention

The present invention will now be described more fully with reference to the accompanying drawings, in which exemplary embodiments of the invention are shown. The following description and the attached drawings are provided for better understanding of the invention, and descriptions of techniques or structures related to the present invention which would be obvious to one of ordinary skill in the art will be omitted.

The specification and drawings should be considered in a descriptive sense only and not for purposes of limitation. Therefore, the scope of the invention is defined by the appended claims. The terms and words which are used in the present specification and the appended claims should not be construed as being confined to common meanings or dictionary meanings but should be construed as meanings and concepts matching the technical spirit of the present invention in order to describe the present invention in the best fashion.

The present invention will now be described more fully with reference to the accompanying drawings, in which exemplary embodiments of the invention are shown.

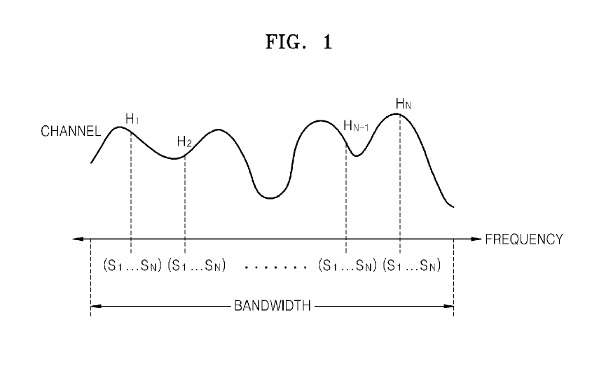

FIG. 1 is a graph illustrating frequency selective fading.

In a wireless mobile communication system, frequency-selective fading occurs, that is, a channel in a frequency domain varies due to multipaths. If a channel is estimated in the frequency domain, data from deep fading is greatly affected by the estimated channel.

Accordingly, the present invention is characterized in that the same data is transmitted to N different frequency channels, where N is a natural number. In FIG. 1, s₁, s₂, through to s_{N} are data signals. H₁, H₂, through to H_{N-1}, and H_{N} are values of channel components in the frequency domain.

For convenience, it is assumed that an orthogonal frequency division multiplexing (OFDM) transmission scheme, which is a multi-carrier transmission scheme, is used and N=2. It is to be understood that the present invention is not limited to the present embodiment and various methods of combining s₁, s₂, through to s_{N} may be used according to the value of N.

When N=2, s₀ and s₁ are two pieces of data modulated into constellation points, and a method of combining the two pieces of data s₀ and s₁ so that the two pieces of data s₀ and s₁ can be separated and demodulated by a receiver is shown in

Xₖ=(s₀+s₁), and

X_{k+α}=(s₀−s₁) (1),

where Xₖ is a symbol in the constellation obtained by summing up the two pieces of data s₀ and sᵢ, which is to be mapped to a k^{th} subcarrier, and X_{k+α} is a symbol in the constellation obtained by subtracting the piece of data s₁ from the piece of data s₀, which is to be mapped to a (k+α)^{th} subcarrier that is spaced more than a coherent bandwidth apart. Pieces of data other than the pieces of data sₒ and sᵢ are mapped to subcarriers other than the k^{th} subcarrier and the (k+α)^{th} subcarrier in the same manner.

Various techniques may be used to map data to a subcarrier that is spaced more than a coherent bandwidth apart. For example, a subcarrier allocation technique of the orthogonal frequency division multiplexing (OFDM) transmission scheme is used in the present invention. Through the subcarrier allocation technique, the data to be transmitted will be mapped in the subcarriers after modulating bit streams into constellation points and combining adjacent pieces of data by method which is described above. Once all of the symbols are mapped to the subcarriers, the symbols are transmitted using the OFDM transmission scheme.

Signals received by the receiver are given by Equation 2. The receiver performs fast Fourier transformation (FFT) on the received signals and converts the received signals into signals in the frequency domain.

Yₖ=(s₀+s₁)Hₖ+Wₖ, and

Y_{k+α}=(s₀s₁)H_{k+α}+W_{k+α} (2),

where Yₖ and Y_{k+α} are signals received by the k^{th} and (k+α)^{th} subcarriers, Hₖ and H_{k+α} are channel components of the k^{th} and (k+α)^{th} subcarriers, and Wₖ and W_{k+α} are k^{th} and (k+α)^{th} white noise components.

In order to estimate a channel component of each subcarrier, the receiver performs complex multiplication on the received signals Yₖ and Y_{k+α} as shown in

Cₖ=1/\tilde{H}ₖ

C_{k+α}=1/\tilde{H}_{k+α}

Zₖ=Yₖ·Cₖ

Z_{k+α}=Y_{k+α}·C_{k+α} (3),

where \tilde{h}ₖ and \tilde{h}_{k+α} are estimated channel components of the k^{th} and (k+α)^{th} subcarriers and Cₖ and C_{k+α} are reciprocals of the estimated channel components.

In Equation 3, assuming that the estimated channel components \tilde{h}ₖ and \tilde{h}_{k+α} are the same as the channel components Hₖ and H_{k+α}, Zₖ and Z_{k+α} are calculated as shown in Equation 4 below.

$$\begin{matrix}\begin{matrix}{Z}_{k} = ( {s}_{0} + {s}_{1} ) \frac{{H}_{k}}{{\tilde{H}}_{k}} + \frac{{W}_{k}}{{\tilde{H}}_{k}} \\ = ( {s}_{0} + {s}_{1} ) \frac{{H}_{k} \cdot {H}_{k}^{*}}{{H}_{k} \cdot {H}_{k}^{*}} + \frac{{W}_{k} \cdot {H}_{k}^{*}}{{H}_{k} \cdot {H}_{k}^{*}} \\ = ( {s}_{0} + {s}_{1} ) + \frac{{W}_{k} \cdot {H}_{k}^{*}}{{\vert {H}_{k} \vert}^{2}} , and\end{matrix} \\ \begin{matrix}{Z}_{k + α} = ( {s}_{0} - {s}_{1} ) \frac{{H}_{k + α}}{{\tilde{H}}_{k + α}} + \frac{{W}_{k + α}}{{\tilde{H}}_{k + α}} \\ = ( {s}_{0} - {s}_{1} ) \frac{{H}_{k + α} \cdot {H}_{k + α}^{*}}{{H}_{k + α} \cdot {H}_{k + α}^{*}} + \frac{{W}_{k + α} \cdot {H}_{k + α}^{*}}{{H}_{k + α} \cdot {H}_{k + α}^{*}} \\ = ( {s}_{0} - {s}_{1} ) + \frac{{W}_{k + α} \cdot {H}_{k + α}^{*}}{{\vert {H}_{k + α} \vert}^{2}} .\end{matrix}\end{matrix} \qquad ( 4 )$$

Calculations, as shown in Equation 5, are carried out in order to separate and demodulate desired data components using Equation 4.

$$\begin{matrix}\begin{matrix}{Z}_{k} + {Z}_{k + α} = ( {s}_{0} + {s}_{1} ) + \frac{{W}_{k} \cdot {H}_{k}^{*}}{{\vert {H}_{k} \vert}^{2}} + ( {s}_{0} - {s}_{1} ) + \frac{{W}_{k + α} \cdot {H}_{k + α}^{*}}{{\vert {H}_{k + α} \vert}^{2}} \\ = 2 {s}_{0} + \frac{{W}_{k} \cdot {H}_{k}^{*}}{{\vert {H}_{k} \vert}^{2}} + \frac{{W}_{k + a} \cdot {H}_{k + α}^{*}}{{\vert {H}_{k + α} \vert}^{2}} \\ = 2 {s}_{0} + \frac{{W}_{k} \cdot {H}_{k}^{*} \cdot {\vert {H}_{k + a} \vert}^{2} + {W}_{k + α} \cdot {H}_{k + α}^{*} \cdot {\vert {H}_{k} \vert}^{2}}{{\vert {H}_{k} \vert}^{2} + {\vert {H}_{k + α} \vert}^{2}} , and\end{matrix} \\ \begin{matrix}{Z}_{k} - {Z}_{k + α} = ( {s}_{0} + {s}_{1} ) + \frac{{W}_{k} \cdot {H}_{k}^{*}}{{\vert {H}_{k} \vert}^{2}} - ( {s}_{0} - {s}_{1} ) - \frac{{W}_{k + α} \cdot {H}_{k + α}^{*}}{{\vert {H}_{k + α} \vert}^{2}} \\ = 2 {s}_{1} + \frac{{W}_{k} \cdot {H}_{k}^{*}}{{\vert {H}_{k} \vert}^{2}} - \frac{{W}_{k + α} \cdot {H}_{k + α}^{*}}{{\vert {H}_{k + α} \vert}^{2}} \\ = 2 {s}_{1} + \frac{{W}_{k} \cdot {H}_{k}^{*} \cdot {\vert {H}_{k + α} \vert}^{2} - {W}_{k + α} \cdot {H}_{k + α}^{*} \cdot {\vert {H}_{k} \vert}^{2}}{{\vert {H}_{k} \vert}^{2} + {\vert {H}_{k + α} \vert}^{2}} .\end{matrix}\end{matrix} \qquad ( 5 )$$

Transmitted signals may be estimated using Equation 5 as shown in Equation 6 below.

$$\begin{matrix}\begin{matrix}{\tilde{s}}_{0} = {s}_{0} + \frac{{W}_{k}^{′}}{2 ( {\vert {H}_{k} \vert}^{2} + {\vert {H}_{k + α} \vert}^{2} )} \\ = {s}_{0} + {W}_{k}^{″} , and\end{matrix} \\ \begin{matrix}{\tilde{s}}_{1} = {s}_{1} + \frac{{W}_{k + α}^{′}}{2 ( {\vert {H}_{k} \vert}^{2} + {\vert {H}_{k + α} \vert}^{2} )} \\ = {s}_{1} + {W}_{k + α}^{″} .\end{matrix}\end{matrix} \qquad ( 6 )$$

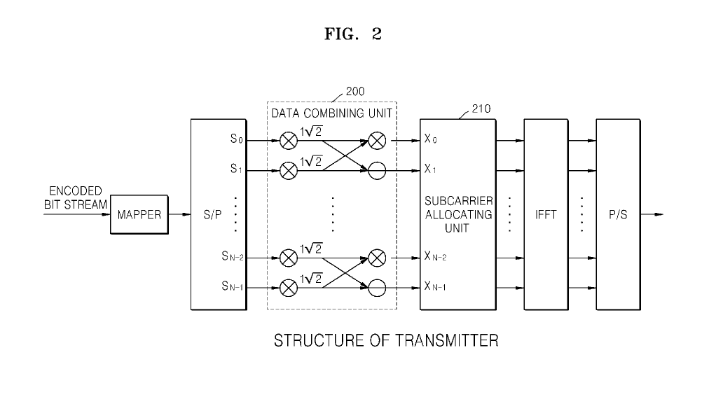

FIG. 2 is a block diagram of a transmitter for combining N pieces of data in the case that the total number of data is L, according to an embodiment of the present invention.

The transmitter may combine and transmit N data signals. The transmitter may combine N different pieces of data so that a receiver can separate and demodulate the N different pieces of data, and may transmit the combined N different pieces of data to N frequency channels. Although it is basically assumed that there is no degradation in data transfer rate, a slight degradation in data transfer rate may occur according to the value of N (where N is a natural number) or a combination method of N data. Even in this case, the N different pieces of data can be combined.

In FIG. 2, the transmitter combines two data signals. The transmitter of FIG. 2 may be realized by adding a data combining unit 200 to a conventional transmitter that uses the OFDM transmission scheme. In FIG. 2, the reason why the data combining unit 200 multiplies data signals s₁, s₂, through by s_{N} by 1/\sqrt{2} is to normalize a data signal level after the two data signals are combined when N=2. Accordingly, if N is changed, 1/\sqrt{2} may be changed.

The data combining unit 200 receives and combines N data signals from an encoded bit stream to obtain N symbols. Next, a subcarrier allocating unit 210 allocates the N symbols obtained by the data combining unit 200 to subcarriers that are spaced more than a coherent bandwidth apart. Accordingly, since the N symbols which are obtained by combining the N data signals are not mapped and not transmitted to subcarriers adjacent to the N symbols, frequency diversity can be achieved.

The data allocating unit 210 may allocate the N symbols to the subcarriers, which are spaced more than a coherent bandwidth apart, in various ways, such as by using a subcarrier allocation technique of the OFDM transmission scheme.

That is, the subcarrier allocation technique involves modulating N pieces of data to be transmitted to constellation points, combining adjacent pieces of data via the data combining unit 200 to obtain N symbols, and mapping the N symbols via the subcarrier allocating unit 210 to subcarriers. Once the N symbols are mapped to the subcarriers, the N symbols are transmitted using the OFDM transmission scheme.

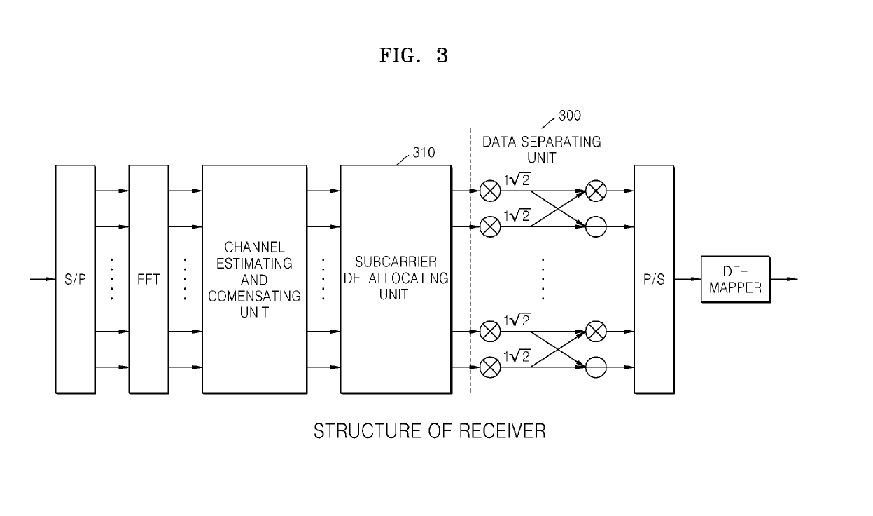

FIG. 3 is a block diagram of a receiver according to an embodiment of the present invention.

The receiver separates N pieces of data received from the transmitter of FIG. 2. In FIG. 3, it is assumed that N=2. A data separating unit 300 and a subcarrier de-allocating unit 310 of the receiver of FIG. 3 perform inverse functions of the functions of the data combining unit 200 and the subcarrier allocating unit 210 of the transmitter of FIG. 2, respectively.

The subcarrier de-allocating unit 310 extracts the N symbols from the subcarriers that are spaced more than a coherent bandwidth apart which are received from the transmitter, and the data separating unit 300 extracts the N data signals from the N symbols.

The subcarrier de-allocating unit 310 of the receiver of FIG. 3 performs the inverse function of the function of the subcarrier allocating unit 210 of the transmitter of FIG. 2. That is, the subcarrier de-allocating unit 310 moves the N symbols, which are generated by the data combining unit 200, to their own positions from positions that are spaced more than a coherent bandwidth apart.

The data separating unit 300 separates N pieces of data from the N symbols, which are moved to their own positions, and performs demodulation. The data separating unit 300 of the receiver of FIG. 3 performs the inverse function of the function of the data combining unit 200 of the transmitter of FIG. 2. The data separating unit 300 separates the N pieces of data from the N symbols of data by solving N equations and performs modulation.

Alternatively, if a single-carrier transmission scheme is used, the transmitter of FIG. 2 may perform FFT on signals, which have passed through a mapper, in the time domain to generate signals in a frequency domain. The transmitter performs inverse fast Fourier transformation (IFFT) on the generated signals, which have passed through the data combining unit 200 and the subcarrier allocating unit 210, in the frequency domain to transmit a single carrier. The receiver performs FFT on the single carrier transmitted by the transmitter to estimate and compensate for channels, and may further perform IFFT to the single carrier, which have passed through the subcarrier de-allocating unit 310 and the data separating unit 300, thereby achieving a similar effect in the single-carrier transmission scheme to that achieved by the multi-carrier transmission scheme.

For example, if N=3, combinations as shown in Equation 7 may be made.

However, the present invention is not limited thereto, and other combinations may be made.

Xₖ=(s₀+s₁+s₂),

X_{k+α}=(s₀+s₁−s₂), and

X_{k+β}=(s₀−s₁+s₂) (7).

If N=2, the receiver may separate and demodulate desired data in a similar manner to that described above as shown in

\tilde{S}₀=(Y_{k+α}/H_{k+α}+Y_{k+β}/H_{k+β})/2,

\tilde{S}₁=(Yₖ/Hₖ−Y_{k+β}/H_{k+β})/2, and

\tilde{S}₂=(Yₖ/Hₖ−Y_{k+α}/H_{k+α})/2.

Even when N is higher than 3, signals may be combined in a similar manner to that described with reference to Equations 1 through 8.

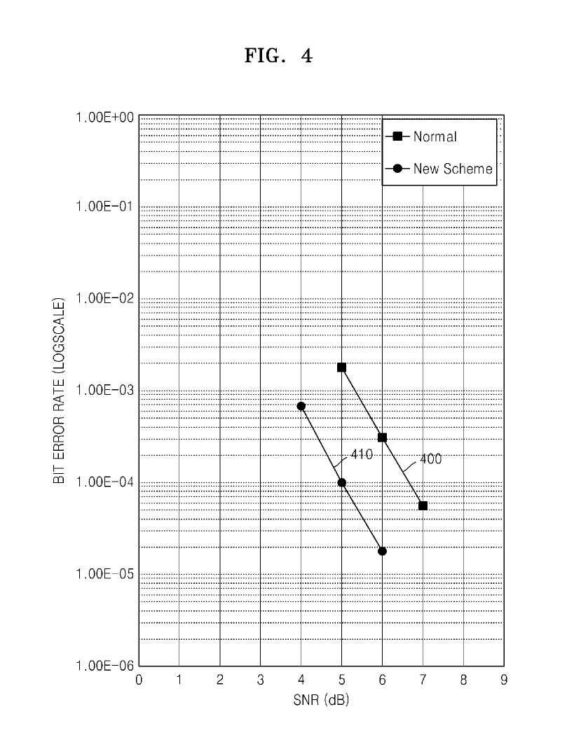

FIG. 4 is a graph illustrating performance of transmitting method according to an embodiment of the present invention, which is achieved when quadrture phase-shift keying (QPSK) is used at a code rate of 1/2 according to the IEEE802.22 standard.

A line 410, which represents a case where a transmission scheme according to the present invention is used, has a signal-to-noise (SNR) gain that is higher than that of a line 400, which represents a case where a conventional transmission scheme is used. The present invention can be applied to a receiver and a transmitter including at least one antenna. Accordingly, a multiple antenna may be used in order to achieve additional space diversity. Furthermore, the present invention can be cooperatively used with time and frequency diversity schemes such as time hopping and frequency hopping.

The present invention can be applied to both a multi-carrier transmission system and a single-carrier transmission system. Also, since the present invention can be applied to a multi-input/multi-output (MIMO) system, a multi-input/single-output (MISO) system, and a single-input/multi-output (SIMO) system as well as a single-input/single-output (SISO) antenna system, the present invention can be used in a multiple antenna system or a method using a variance receiver.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A transmitter comprising:
a data combining unit combining N data signals received from an encoded bit stream to generate N symbols; and
a subcarrier allocating unit mapping the N symbols to subcarriers that are spaced more than a coherent bandwidth apart.

2. The transmitter of claim 1, wherein the subcarrier allocating unit uses a subcarrier allocation technique of an orthogonal frequency division multiplexing (OFDM) transmission scheme.

3. The transmitter of claim 1, wherein the data combining unit combines the N data signals to form N equations.

4. The transmitter of claim 1, further comprising at least one antenna.

5. The transmitter of claim 1, wherein the transmitter uses a multi-carrier transmission scheme or a single-carrier transmission scheme.

6. A receiver comprising:
a receiving unit receiving N symbols that are generated by combining N data signals and are mapped to subcarriers that are spaced more than a coherent bandwidth apart;
a subcarrier de-allocating unit moving the N symbols, which are mapped to the subcarriers that are spaced more than a coherent bandwidth apart, to their own original positions; and
a data separating unit separating N pieces of data from the N symbols, which are moved to their own positions and demodulating the N pieces of data.

7. The receiver of claim 6, wherein the data separating unit separates the N pieces of data by deriving N equations from the N symbols that are generated by using the N data signals, and demodulates the N pieces of data.

8. The receiver of claim 6, wherein the receiver comprises at least one antenna.

9. The receiver of claim 6, wherein the receiver uses at least one of a multi-carrier transmission scheme and a single-carrier transmission scheme.

10. A system for transmitting and receiving data, the system comprising the transmitter of claim 1, and a receiver comprising:
a receiving unit receiving N symbols that are generated by combining N data signals and are mapped to subcarriers that are spaced more than a coherent bandwidth apart;
a subcarrier de-allocating unit moving the N symbols, which are mapped to the subcarriers that are spaced more than a coherent bandwidth apart, to their own original positions; and
a data separating unit separating N pieces of data from the N symbols, which are moved to their own positions and demodulating the N pieces of data.

11. A method of transmitting and receiving data in a system for transmitting and receiving data using a frequency diversity scheme, the method comprising:
combining N data signals received from an encoded bit stream to generate N symbols;
mapping the N symbols to subcarriers that are spaced more than a coherent bandwidth apart;
receiving and moving the N symbols, which are mapped to the subcarriers that are spaced more than a coherent bandwidth apart, to their own positions; and
separating N pieces of data from the N symbols, which are moved to their own positions, and demodulating the N pieces of data.
